(19) United States
(12) Patent Application Publication
(10) Pub. No.: US 2016/0161339 A1
(43) Pub. Date: Jun. 9, 2016

(54) HUMAN MOTION DETECTION

(71) Applicant: Intel Corporation, Santa Clara, CA (US)

(72) Inventor: Flora Tan, New York, NY (US)

(73) Assignee: Intel Corporation, Santa Clara, CA (US)

(21) Appl. No.: 14/562,391

(22) Filed: Dec. 5, 2014

(51) Int. Cl. G01J 5/00

(52) U.S. Cl. CPC G01J 5/0025

(57) ABSTRACT

A system configured to collect sensor data and compare the sensor data to a first template profile comprising data indicative of an approach of a user or compare the sensor data to a second template profile comprising data indicative of a departure of a user, or a combination thereof to determine whether the sensor data indicates the approach of a user or a departure of a user.

### TECHNICAL FIELD

Examples described herein generally relate to methods, systems, and devices to detect user motion.

### BACKGROUND

Determining human presence or absence in front of a computing device may require expensive hardware and tax processing resources.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram illustrating an example of a device configured to detect a user motion;

FIG. 2 is a block diagram illustrating an example of a device configured to detect user motion;

FIG. 3 is a diagram illustrating an example of a system for analyzing user motions to identify an intent to engage a device;

FIG. 4 is a diagram illustrating an example of a system for analyzing user motions to identify an intent to disengage a device;

FIG. 5 is a diagram illustrating an example of a data structure for selecting one or more template profiles to compare with sensor data;

FIG. 6 illustrates an example of a process to detect a presence or absence of a user in an area to trigger analysis of user motions by a device;

FIG. 7 is a flow diagram illustrating an example process for determining a presence or absence of a user in an area;

FIG. 8 illustrates an example of a process to analyze user motions to determine if a user is likely to engage or disengage from device; and

FIG. 9 is a block diagram of an exemplary information handling system capable of implementing a system for analyzing user motions.

### DETAILED DESCRIPTION

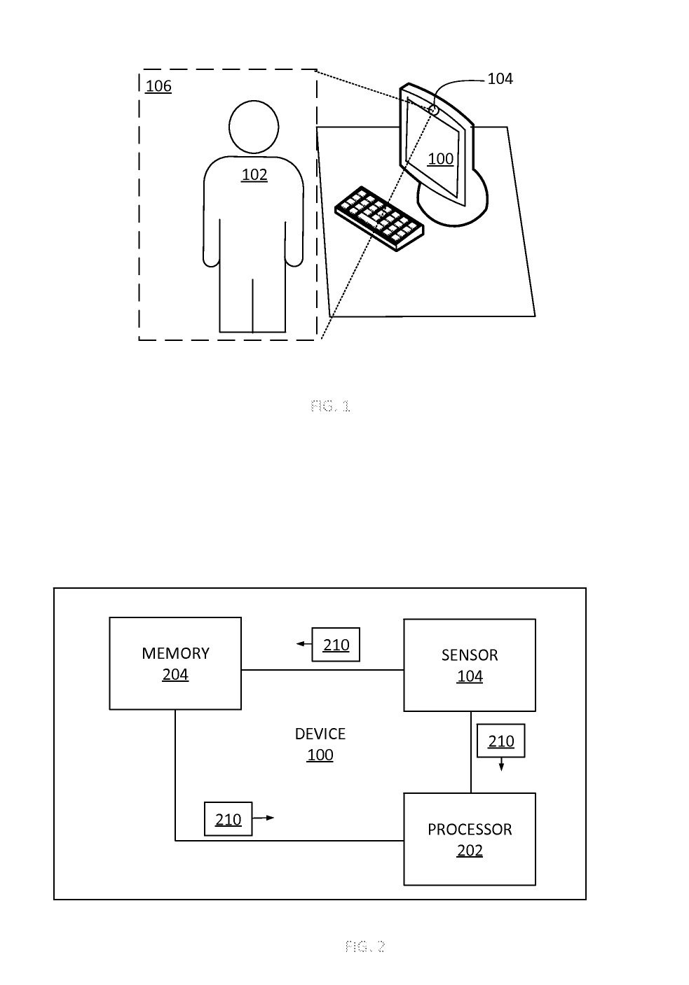

FIG. 1 is a diagram illustrating an example of a device 100 configured to detect a user motion. User motions may be analyzed to determine whether or not a user 102 is likely to start using or stop using device 100. In an example, if user 102 approaches, departs from or otherwise moves into a position to engage or disengage device 100, user 102 may execute one or more motions that are characteristic of an intent to engage and/or disengage device 100. Sensor 104 may be coupled to device 100 and may be configured to detect such motions within an area 106 and collect sensor data associated with the detected motions. Area 106 may be a predefined area proximate device 100 and/or may be an area within range of sensor 104, or the like or a combination thereof. Area 106 may comprise a field of view of sensor 104. Sensor 104 may send sensor data to memory to be stored and/or send the sensor data to a processor for processing to determine whether or not a user 102 is likely to start using or stop using device 100 based on the sensor data. Sensor 104 may be configured to transmit sensor data via a wireless communication system and/or via wireline communications. Such a wireless communication system may include, a Radio Frequency Identification (RFID) system, a Wi-Fi™ system, a Bluetooth™ system, a Zigbee™ system, WiMax™ system, or the like or a combination thereof.

In an example, device 100 may be coupled to one sensor 104 or more than one sensor 104. Sensor 104 may be physically in contact with device 100 or may be remote and not physically in contact with device 100. Where there are two or more sensors 104 one or more sensors 104 may be in physical contact with device 100. Sensor 104 may comprise any of a variety of sensors, such as: an infra-red (IR) image sensor, a thermal image sensor, an optical sensor, an electro-optical sensor, an ultrasonic sensor, a light sensor, a biometric sensor, a pressure sensor, a microwave sensor, an image sensor, a motion sensor or a video sensor, or the like or a combination thereof. Device 100 may comprise any of a variety of devices, such as: a desktop computer, a laptop computer, a mobile communications device, a mobile computing device, a tablet, a notebook, a detachable slate device, an Ultrabook™ system, a wearable communications device, or a wearable computer, or a combination thereof.

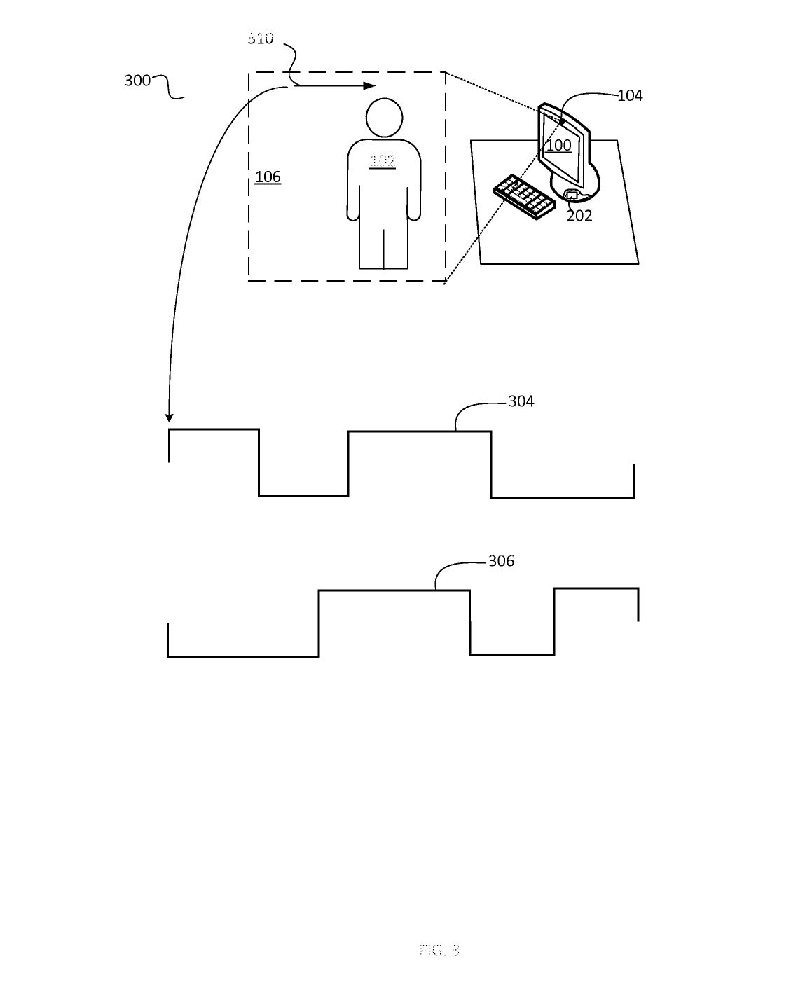

FIG. 2 is a block diagram illustrating an example of a device 100 configured to detect user motion. Sensor 104 may detect and capture sensor data 210 associated with area 106. Sensor 104 may send sensor data 210 to processor 202 and/or may send sensor data 210 to be stored in memory 204. Sensor data 210 may be post-processed, filtered, and/or normalized. In an example, sensor 104 may record sensor data 210 at predetermined intervals by sampling, when triggered by an event and/or on a periodic or continuous basis. An event that may trigger recording of sensor data 210 may comprise detection of user 102 entering and/or leaving area 106.

In an example, processor 202 may receive sensor data 210 from sensor 104. Processor 202 may analyze sensor data 210 to determine whether user 102 is likely to engage device 100 or likely to disengage from or discontinue use of device 100. In an example, processor 202 may process sensor data 210 on a periodic and/or continuous basis such as at predetermined time intervals, during sampling, when triggered by an event and/or on a continuous basis. The likelihood that a user intends to engage or disengage device 100 may be inferred by processor 202 from a user's motions in the vicinity of device 100. For example, processor 202 may be configured to identify based on sensor data 210 whether user 102 is approaching device 100 in area 106 and/or identify based on sensor data 210 if user 102 is departing from area 106 proximate device 100. Processor 202 may determine that a user is likely to engage device 100 if processor 202 determines that user 102 is approaching device 100. Likewise, processor 202 may determine that a user is likely to disengage from device 100 if processor 202 determines that user 102 is departing from area 106.

In an example, processor 202 may detect an intent of user 102 to engage or disengage device 100 based on identifying a change in a sample of sensor data 210 from a previously collected sample of sensor data 210, identifying a change from a norm in sensor data 210 and/or a comparison of sensor data 210 to a template profile. Such a change in sensor data 210 may be caused by user 102 entering or leaving area 106 and/or or other user motions indicative of an intent to engage or disengage device 100.

In an example, sensor 104 may read a moving window of sensor data 210. A moving window herein may refer to a set of sensor 104 readings having a particular sample size and/or taken in a particular time interval. The moving window may comprise, for example, sensor data 210 comprising the previous n seconds of data recorded, the previous n data points and/or the like or combination thereof. Any of a variety of moving window parameters may be set. A moving window of sample data changes as sample data points are read and new data points are added to a frame of the moving window and older points sample data points are discarded.

In an example, motions user 102 may make indicative of their intent to engage and/or disengage device 100 may vary widely and may depend upon the context within which device 100 is to be used. Processor 202 may be configured to analyze sensor data 210 based on a context of device 100. Such context may include the type of device 100 to be engaged and/or disengaged, whether the device is being used indoors or outdoors, whether device 100 is being used at home or in the office, whether device 100 is disposed on a traditional desk or a standing desk and the like, or combinations thereof.

In an example, in a context where device 100 comprises a desktop computer disposed on a traditional desk, motions user 102 may execute indicative of an intent to engage or disengage device 100 may include: walking up to device 100, walking away from device 100, sitting down in front of device 100, rising from a sitting position in front of device 100 and/or the like or combinations thereof. In another example, device 100 may be a mobile computing device. In such a context, motions user 102 may execute indicative of their intent to engage and/or disengage device 100 may comprise: picking device 100 up, moving device 100 into position in front of user 102, setting device 100 on the lap of user 102, lifting device 100 off of the lap of user 102, setting device 100 down on a surface, or the like or a combination thereof.

In an example, processor 202 may trigger one or more actions based on a determination of whether or not user 102 is likely to engage device 100 or likely to disengage from or discontinue use of device 100. Examples of such actions include and are not limited to: an authentication process, a password process, a wake-up process, a facial recognition process, a shutdown process, an energy saving mode, a secure mode, an upload of data, a download of data, an alarm or the like, and/or a combination thereof.

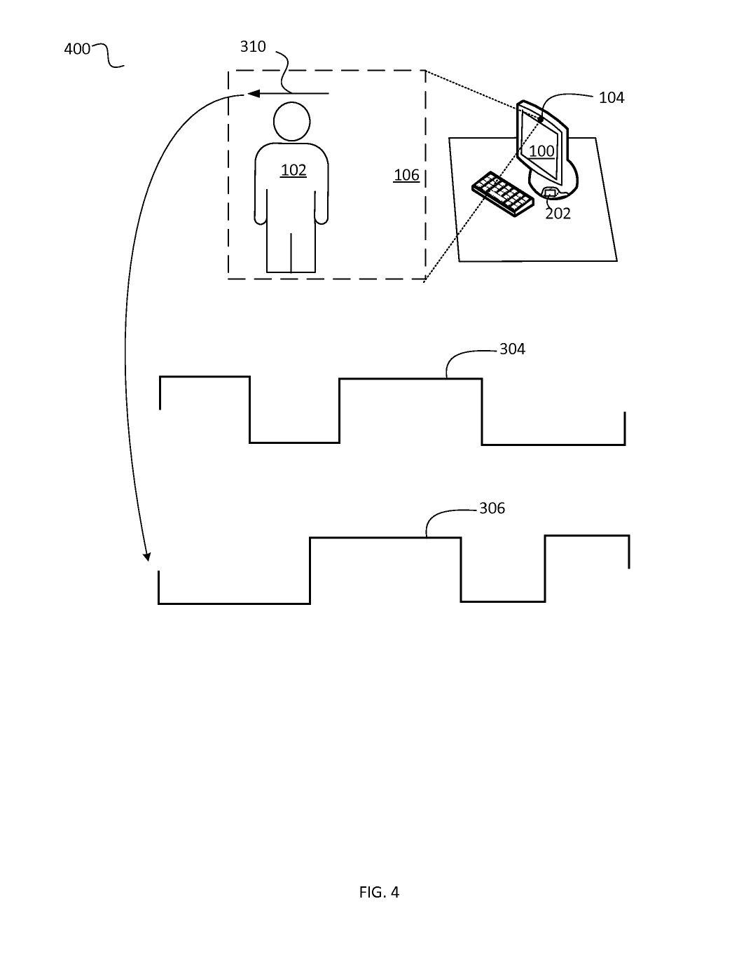

FIG. 3 is a diagram illustrating an example of a system 300 for analyzing user 102 motions to identify an intent to engage a device 100. In an example, user 102 may approach device 100 moving in the direction of arrow 310. Processor 202 may detect user 102 in area 106 based on sensor data 210 corresponding to motions user 102 may make while approaching device 100. In an example, processor 202 may compare sensor data 210 to one or more template profiles which may be stored in memory 204. Sensor data 210 may comprise a waveform. Processor 202 may access the one or more template profiles from memory 204. Such template profiles may comprise first waveform 304 and/or second waveform 306. First waveform 304 may represent data characteristic of a user approaching or “walking up” to device 100. Second waveform 306 may represent data characteristic of a user departing from or “walking away” from device 100. First waveform 304 and second waveform 306 are shown for purposes of example in FIG. 3 and FIG. 4. First waveform 304 and second waveform 306 may have different shapes and content than that shown and may comprise analog or digital waveforms and the scope of the claimed subject matter is not limited in this respect.

In an example, processor 202 may be configured to determine and/or quantify a strength of a match between sensor data 210 and either or both of first waveform 304 and/or second waveform 306 to determine whether user 102 is approaching device 100 and/or departing from device 100. Processor 202 may be configured to quantify a match strength between sensor data 210 and first waveform 304 and/or second waveform 306. In an example, processor 202 may be configured to calculate one or more normalized cross-correlation coefficients between sensor data 210 and first waveform 304 and/or between sensor data 210 and second waveform 306 to quantify the match strength between sensor data 210 and first waveform 304 and/or second waveform 306. Processor 202 may be configured to compare the match strength to a threshold match strength, for example, by comparing the one or more normalized cross-correlation coefficients to a threshold coefficient. Memory 204 may store one or more threshold coefficient.

In an example, processor 202 may determine that the normalized cross-correlation coefficient quantifying the match between sensor data 210 and first waveform 304 meets or exceeds a corresponding threshold coefficient. Processor 202 may determine that user 102 is approaching device 100 and may infer that user 102 intends to use device 100 based on such determination. Processor 202 may trigger an action to be executed by device 100 based on determining that user 102 is approaching device 100. An action to be triggered may facilitate use of device 100 by user 102. Such an action may hasten and/or simplify a powering-on process, a booting-up process, an authorization process or the like or a combination thereof. Examples of an action processor 202 may trigger and/or execute responsive to a determination that the normalized cross-correlation coefficient quantifying the match between sensor data 210 and first waveform 304 meets or exceeds a corresponding threshold coefficient may include: switching device 100 to an “ON” state, initiating an authentication process, requesting a password, initiating a facial recognition process, or the like or a combination thereof.

FIG. 4 is a diagram illustrating an example of a system 400 for analyzing user 102 motions in device 100 to identify an intent to disengage a device 100. In an example, user 102 may move away from device 100 in the direction of arrow 410. Sensor 104 may detect user in area 106 and may capture sensor data 210 corresponding to motions user 102 may make while departing from device 100. In an example, processor 202 may compare sensor data 210 to the one or more template profiles. Sensor data 210 may comprise a waveform.

In an example, processor 202 may be configured to determine and/or quantify a strength of a match between sensor data 210 and either or both of first waveform 304 and/or second waveform 306 to determine whether user 102 is approaching device 100 and/or departing from device 100. Processor 202 may be configured to find one or more normalized cross-correlation coefficients by comparing sensor data 210 and first waveform 304 and/or comparing sensor data 210 and second waveform 306. Processor 202 may be configured to compare the one or more normalized cross-correlation coefficient quantifying the strength of a match between sensor data 210 and first waveform 304 and/or sensor data 210 and second waveform 306 with a threshold value such as a threshold coefficient.

In an example, processor 202 may determine that the normalized cross-correlation coefficient quantifying the match between sensor data 210 and second waveform 306 meets or exceeds a corresponding threshold coefficient. Based on such determination, processor 202 may determine that user 102 is departing from device 100 and may infer that user 102 intends to stop using device 100. Processor 202 may trigger an action to be executed by device 100 based on determining that user 102 is departing from device 100. An action to be triggered may hasten and/or simplify a powering-down process, a security process, a management process or the like or a combination thereof. Examples of an action processor 202 may trigger and/or execute responsive to a determination that the normalized cross-correlation coefficient quantifying the match between sensor data 210 and second waveform 306 meets or exceeds a corresponding threshold coefficient may include: toggling device 100 to an “OFF” state, initiating an energy saving mode, beginning a data upload, initiating a security procedure, terminating recording of sensor data, or the like or a combination thereof.

In an example, one or more template profiles such as first waveform 304 and/or second waveform 306 may be selected from memory 204 by processor 202. The one or more template profiles may be obtained from experimental data classifying meaningful motions from sensor 104 readings over one or more samples. The one or more template profiles may each be associated with a particular user action such as “walking up” and/or “walking away.”

In an example, the experimental data may be gathered in and thus associated with a particular context. Such contexts may include: indoors, outdoors, a traditional desktop computer, a standing desktop computer, a mobile device, or the like or a combination thereof. In an example, in a particular context, sensor data 210 may be collected over several samples of a user executing one or more particular motions prior to engaging and/or disengaging a device such as “walking up” to or “walking away” from the device. The device used during experimentation may be representative of a class of devices to which the template profiles may be made applicable such as a desktop computer, laptop computer, mobile phone, tablet, or the like or a combination thereof. The experimental sensor data may be post processed: filtered and/or normalized. A waveform or other graph may be generated to obtain a template profile associated with the particular motions being observed, the device and/or the context.

In an example, a template profile such as first waveform 304 and/or second waveform 306 may be generated by processor 202 during a calibration process. Processor 202 may generate first waveform 304 and/or second waveform 306 by modifying previously stored waveforms based on calibration data. The calibration data may comprise sensor readings captured by sensor 104 taken during a calibration process wherein a user may demonstrate particular motions associated with an intent to engage and/or disengage from device 100. Such calibration may enable increased accuracy in recognizing user motions indicative of an intent to engage and/or disengage device 100.

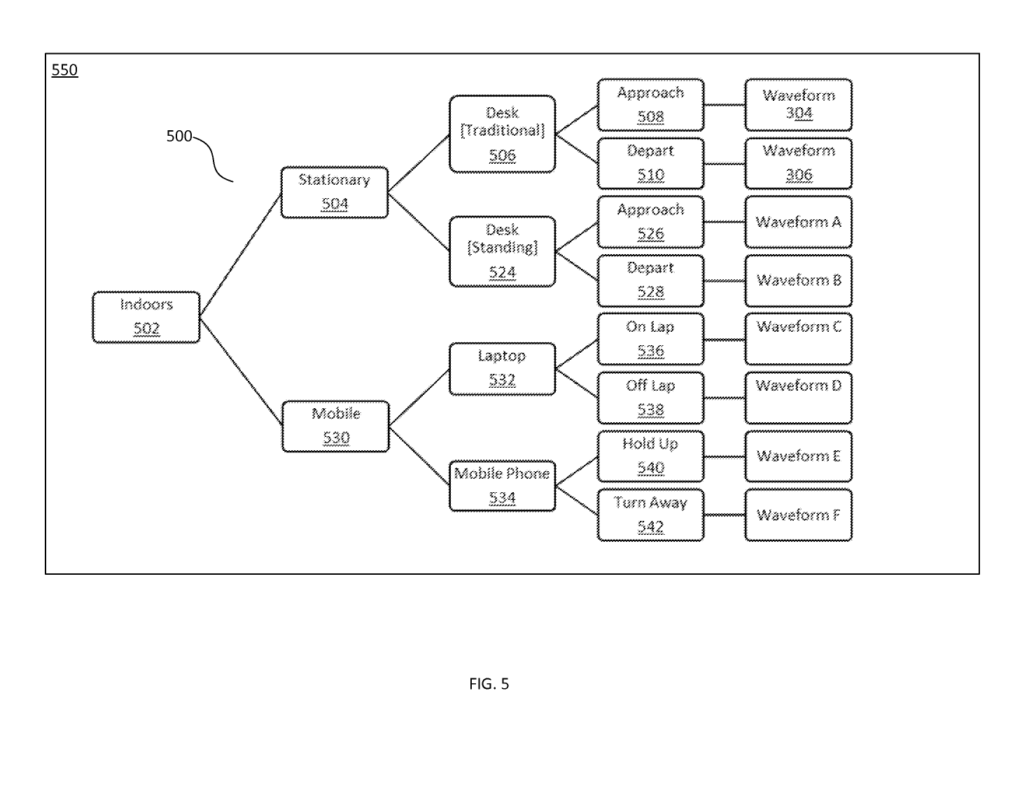

FIG. 5 is a diagram illustrating an example of a data structure 500 for selecting one or more template profiles to compare with sensor data 210. The one or more template profiles may be selected based on a context of device 100. In an example, the one or more template profiles may be mapped to and/or otherwise associated with one or more contexts in data structure 500. For example, first waveform 304 may be mapped to an indoor environment 502, a stationary device 504, a traditional desktop device 506 and an approach 508 of user 102. Similarly, second waveform 306 may be mapped to an indoor environment 502, a stationary device 504, a traditional desktop device 506 and a departure 510 of user 102. Thus, processor 202 may select one or more template profiles to compare with sensor data 210 based on the context of device 100.

In an example, data structure 500 may include several other possible template profile selections, such as, for example, waveforms A-F. Waveforms A-B may be mapped to respective ones of various contexts including: indoor environment 502, stationary device 504, standing desktop device 524, an approach 526 or departure 528 of a user 102, or the like or a combination thereof. Waveforms C-F may be mapped to respective ones of various contexts including indoor environment 502, mobile device 530, laptop computer 532, mobile phone 534, positioning on user lap 536, off user lap 538, holding up 540 and/or turning away 542, or the like or combinations thereof.

In an example, data structure 500 may be stored in a database 550 in memory 204 of device 100. Processor 202 may be configured to access database 550 and select a template profile, such as, for example first waveform 304 and/or second waveform 306 or a combination thereof based on at least one context associated with device 100.

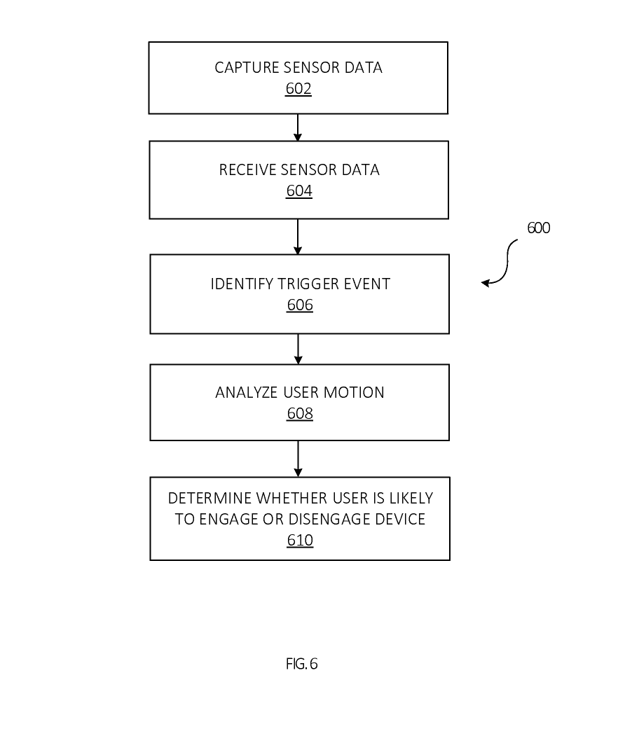

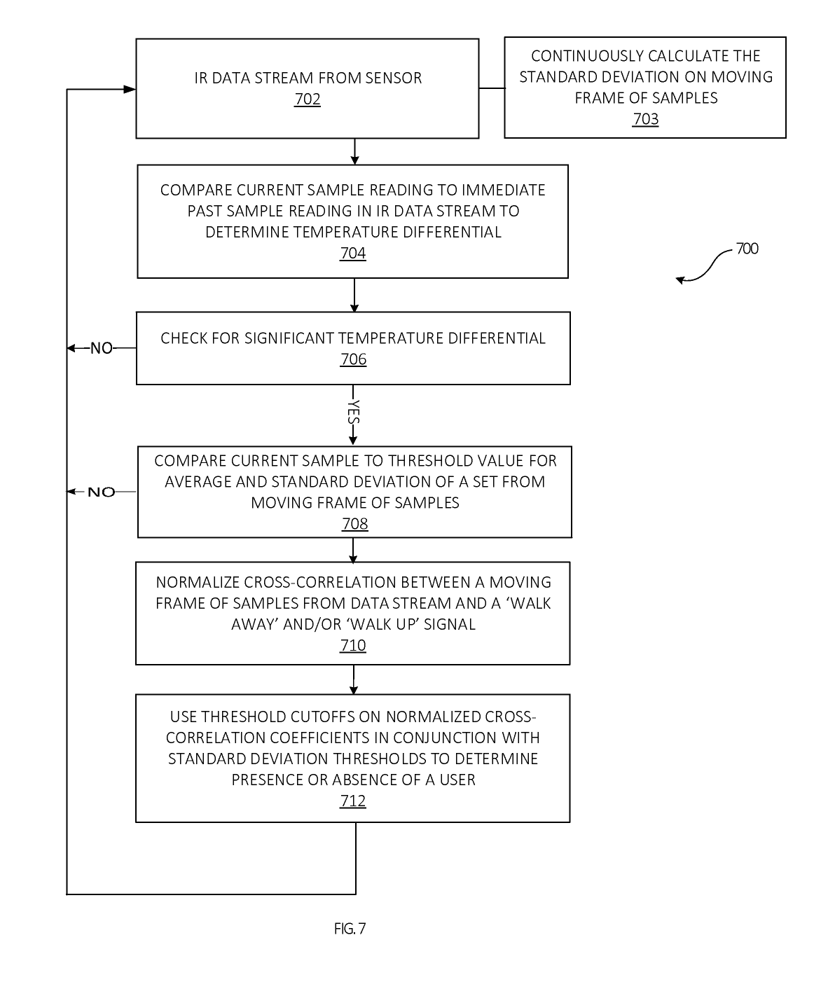

FIG. 6 illustrates an example of a process 600 to detect a presence or absence of a user 102 in area 106 to trigger analysis of user 102 motions by device 100. Process 600 begins at operation 602 where sensor 104 may periodically and/or continuously capture sensor data 210. Moving to operation 604, processor 202 may receive sensor data 210 from sensor 104 and/or memory 204. At operation 606, processor 202 may identify a trigger event. A trigger event may indicate a user 102 intent to engage and/or disengage device 100 such as when user 102 is enters or leaves area 106. In an example, to identify the trigger event, processor 202 may identify a change in a particular metric in sensor data 210, for example, by comparing a current sensor data point with a previous sensor data point. Example metrics may include and are not limited to: temperature, decibel level, activity, motion, pressure, a biological parameter, light, or the like or a combination thereof. Processor 202 may determine that an identified change is significant based on a threshold analysis. If the change is significant based on a threshold analysis, processor 202 may further analyze the sensor data 210. Processor 202 may monitor a norm, such as an average and standard deviation of the particular metric in a moving frame of samples of sensor data 210. Processor 202 may compare the current sensor data point to the average and standard deviation of a previous sample set of the sensor data 210 to determine whether the current sensor data point is within a threshold number of standard deviations from the average. If the current sensor data point is outside of the threshold number of standard deviations from the average, processor 202 may determine that a trigger event has occurred indicating a user 102 intent to engage and/or disengage device 100. If processor 202 identifies a trigger event, process 600 may move to operation 608. At operation 608, processor 202 may analyze user 102 motion responsive to the trigger event. Such analysis of user 102 motion may comprise comparing the sensor data 210 to one or more template profiles representing data associated with a particular user motion. In an example, processor 202 may quantify a quality of a match between sensor data 210 and the one or more template profiles. Processor 202 may analyze the match quality to determine which if any template profile satisfies a threshold standard for match quality. In an example where there is one template profile, processor 202 may determine the template profile is a successful match if the match quality exceeds the threshold match quality. Where there are more than one template profiles, processor 202 may determine that the template profile having the highest match quality that exceeds the threshold standard for match quality is the successful match. At operation 610, processor 202 may determine whether user 102 is likely to engage and/or disengage device 100 based on identifying a successful match to a template profile during the analysis of user motion. In an example, the one or more template profiles are each associated with a particular user motion indicative of an intent to engage or disengage device 100.

In an example of process 600, sensor 104 may be an infrared sensor used to take temperature readings in area 106. At operation 602, a stream of samples of sensor data 210 may be read and captured by sensor 104. At operation 604, processor 202 may receive and process the stream of samples of sensor data 210. At operation 606, processor 202 may identify a trigger event by comparing consecutive temperature readings such as a current temperature reading and a prior temperature reading. A temperature differential between the consecutive temperature readings may be determined to be significant by, for example, comparing the detected temperature differential to a temperature differential threshold. If the temperature differential exceeds the temperature differential threshold the detected temperature differential may be considered significant and processor 202 may proceed to execute subsequent processing of the sensor data 210. Such subsequent processing may comprise determining an average temperature and a standard deviation of a set of samples of sensor data 210 taken prior to the current temperature reading. Processor 202 may compare the current temperature reading to the calculated average and standard deviation of the set of samples to determine whether the current temperature is within a threshold standard deviation. If the current temperature exceeds a threshold standard deviation of the set of samples then processor 202 may proceed to operation 608 to analyze user motions by comparing sensor data 210 to one or more waveforms representing template profile data associated with a user walking up to or walking away from device 100. If a sufficiently high quality match is found based on a threshold match quality analysis between the sensor data 210 and the one or more waveforms, processor 202 may move to operation 610. At operation 610, processor 202 may determine whether user 102 is likely to engage and/or disengage device 100 based on the user motion analysis. Processor 202 may execute an action to facilitate use and/or shut-down of device 100 based on the determination.

FIG. 7 is a flow diagram illustrating an example process 700 for determining a presence or absence of a user 102 in an area 106. At operation 702 processor 202 receives an infrared (IR) data stream from sensor 104 where sensor 104 is an IR sensor. At operation 703, processor 202 may continuously calculate the standard deviation on a moving frame of samples from the IR data stream. Process 700 may proceed from operation 702 to operation 704 where processor 202 may compare a current sample reading to an immediate past sample reading in the IR data stream to identify a temperature differential. At operation 706, processor 202 may check for a significant temperature differential by determining whether the temperature differential is greater than a threshold differential. A significant temperature differential may be an indicator that a person is entering or leaving area 106. Using a threshold check on a temperature differential may indicate possible human movement on the moving window of sensor data samples as a trigger for human presence detection. If the temperature differential is greater than the threshold differential then process 700 may proceed to operation 708. Otherwise, if the temperature differential is not greater than the threshold differential then process 700 may proceed to operation 702. At operation 708, processor 202 may compare the current sample reading with a calculated average and standard deviation of a set of samples in the moving frame of samples from the IR data stream preceding the current sample reading. In an example, the average and standard deviation may have been previously calculated for the set of samples as processor 202 may be configured to continuously calculate an average and standard deviation on the moving frame of samples from the IR data stream. Processor 202 may determine whether the current sample reading is within a threshold standard deviation of the average. If the current sample reading is outside the threshold standard deviation of the average then process 700 may continue to operation 710. At operation 710, processor 202 may normalize a cross-correlation between a moving frame of samples from the data stream and a “walk up” and/or “walk away” signal. A “walk up” and/or “walk away” signal may be obtained for a human user 102 by experiment. This may consist of collected data from the infrared sensor 104 that is post-processed: filtered, and/or normalized. A similarity between the sensor feed and the standardized “walk away” and “walk up”' signals may be quantified by looking at the normalized cross correlation coefficient between the moving frame of samples from the IR data stream and the standardized signals. At operation 712, processor 202 may use threshold cutoffs on normalized cross-correlation coefficients in conjunction with standard deviation thresholds to determine presence and/or absence of user 102 in area 106. Processor 202 may use threshold cutoffs on normalized cross-correlation coefficients found by experimental procedures, in conjunction with standard deviation thresholds that are found by experiment, to determine the presence or absence of a human user 102. Process 700 may proceed to operation 702.

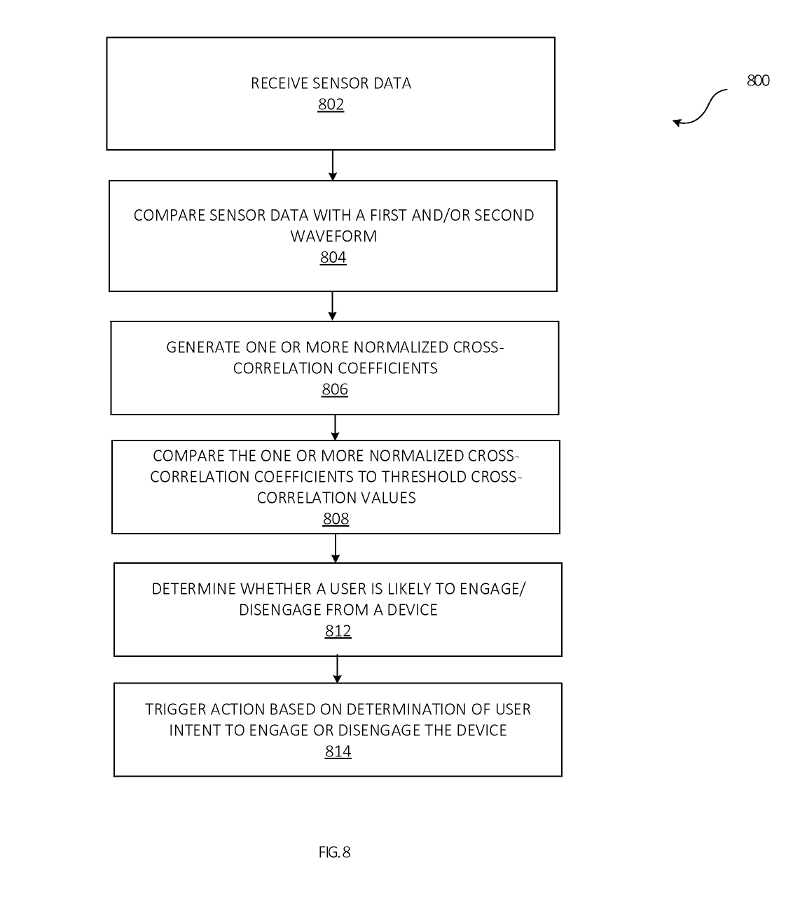

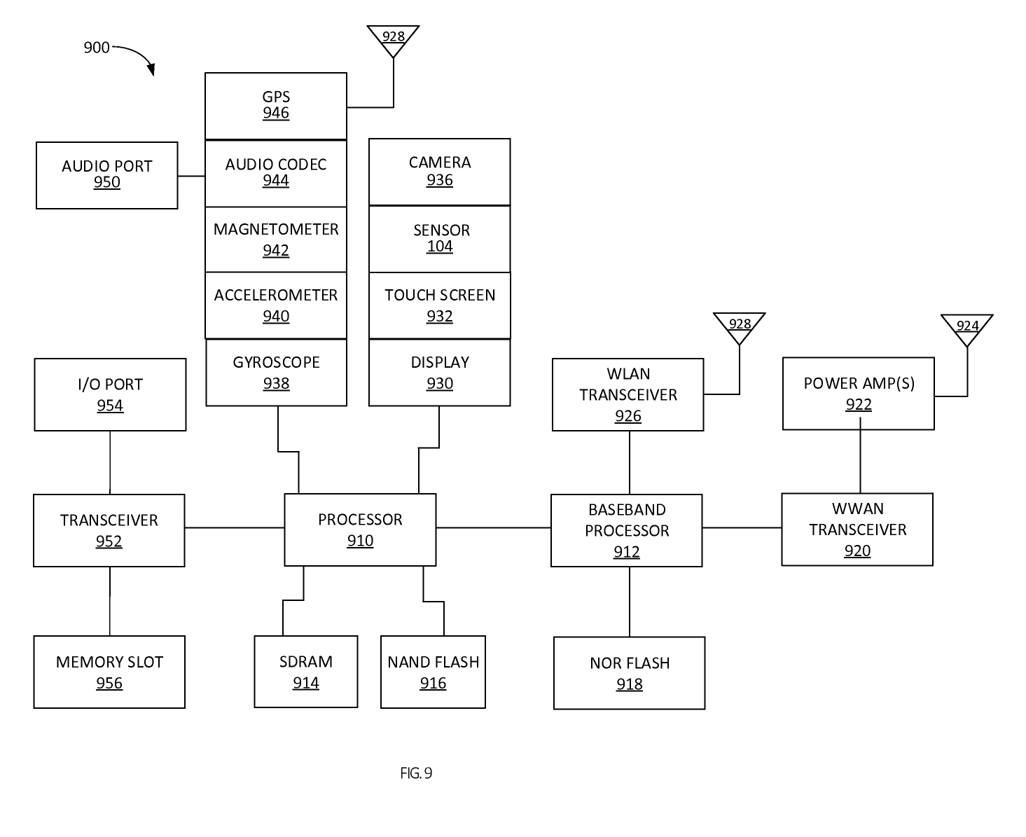

FIG. 8 illustrates an example of a process 800 to analyze user 102 motions to determine if user 102 is likely to engage or disengage from device 100. Process 800 begins at operation 802 where processor 202 may receive sensor data to be analyzed. Sensor 104 may periodically and/or continuously capture sensor data 210 and send sensor data 210 to processor 202. The sensor data 210 may be based on a moving frame of sensor 104 readings. At operation 804, processor 202 may compare the sensor data 210 with a first waveform 304 and/or a second waveform 306 to determine whether user 102 is likely to engage or disengage from device 100. First waveform 304 and/or a second waveform 306 may be selected from a database and/or generated by processor 202 responsive to sensor data 210. Selection of the first waveform 304 and/or second waveform 306 may be based on context. In an example, the first waveform 304 may comprise a shape having characteristic features associated with motions a user 102 may make with an intent to engage device 100. The second waveform 306 may comprise a shape having characteristic features associated with motions a user 102 may make with an intent to disengage from device 100. At operation 808, processor 202 may generate one or more normalized cross-correlation coefficients based on the comparison of sensor data 210 with the first waveform 304 and/or the second waveform 306. For example, processor 202 may generate a first normalized cross-correlation coefficient based on a comparison of sensor data 210 and the first waveform 304. Processor 202 may generate a second normalized cross-correlation coefficient based on a comparison of sensor data 210 and the second waveform 306. At operation 810, processor 202 may compare the one or more normalized cross-correlation coefficients to a threshold coefficient value. For example, processor 202 may compare the first normalized cross-correlation coefficient with the threshold coefficient value and/or may compare the second normalized cross-correlation coefficient with the threshold coefficient value.

At operation 812, processor 202 may determine whether user 102 is likely to engage and/or disengage with device 100 based on the comparison of the one or more normalized cross-correlation coefficients to a threshold coefficient value. For example, if first normalized cross-correlation coefficient meets or exceeds a threshold coefficient value then processor 202 may determine that user 102 is present in area 106 and intends to engage device 100. If second normalized cross-correlation coefficient meets or exceeds a threshold coefficient value then processor 202 may determine that user 102 is absent from or leaving area 106 and intends to disengage device 100. At operation 814, processor 202 may trigger an action based on the determining whether user 102 is likely to engage or disengage device 100.

Disclosed herein are examples of one or more methods for receiving sensor data representative of temperature information captured in a field of view of an infrared (IR) sensor, detecting if a temperature differential in the received sensor data exceeds a threshold value, quantifying a similarity between the sensor data received during the detected temperature differential and one or more stored profiles and determining a presence or an absence of a user in the field of view of the IR sensor based on the similarity between the data received during the detected temperature differential and at least one of the stored profiles. In an example, the quantifying may comprise normalizing a cross-correlation between the sensor data received during the detected temperature differential and the one or more stored profiles. In an example, one or more stored profiles may comprise a profile for a user entering the field of view of the IR sensor and/or a profile for a user exiting the field of view of the IR sensor. The one or more methods may further comprise updating at least one of the stored profiles with the data received during the detected temperature differential if said determining determines the presence or absence of the user. The one or more methods may further comprise continuously calculating a standard deviation on frames of samples in the sensor data and using a standard deviation threshold in said determining to determine a presence or absence of the user. The one or more methods may further comprise authorizing the user to access an electronic device if the sensor data received during the detected temperature differential matches one of the one or more stored profiles.

Disclosed herein are examples of one or more devices to detect a user approach or departure or a combination thereof, comprising a sensor to collect sensor data and a processor to compare the sensor data to a first template profile comprising data indicative of an approach of a user or compare the sensor data to a second template profile comprising data indicative of a departure of a user, or a combination thereof to determine whether the sensor data indicates the approach of a user or a departure of a user. In an example, the processor may be further configured to trigger a first action if the sensor data indicates the approach of the user and trigger a second action if the sensor data indicates the departure of the user, or a combination thereof, quantify a similarity between the sensor data and the first template profile to generate a first normalized cross correlation coefficient between the sensor data and the first template profile and quantify a similarity between the sensor data and the second template profile to generate a second normalized cross correlation coefficient between the sensor data and the second template profile. In an example, the processor may be configured to compare a threshold coefficient value with the first cross correlation coefficient or the second cross correlation coefficient, or a combination thereof to identify the approach or departure of the user. In an example, the first template profile may be a first waveform and the second template profile is a second waveform. In an example, the processor may be configured to select the first waveform or the second waveform or a combination thereof based on a context of the device. In an example, the context of the device corresponds to whether the device is indoors, outdoors, a desktop device, a mobile device, a laptop device, or a slate device or a combination thereof. In an example, the first template profile or the second template profile or a combination thereof is based on experimental data correlated to context. In an example, the processor may derive the first template profile or the second template profile or a combination thereof from supplemental sensor data collected during a calibration process. In an example, the first template profile or the second template profile or a combination thereof may be based on data that is filtered or normalized or a combination thereof. In an example, the processor may determine a differential between a first sample value and a second sample value of the sensor data measuring a particular metric, compare the differential to a threshold differential value, responsive to the differential exceeding the threshold differential value, trigger determination of an average value and a standard deviation of the average value of the particular metric for a set of samples of the sensor data, compare the first sample value with the average and determine whether the first sample value is within a threshold standard deviation of the average value and responsive to the first sample value exceeding the threshold standard deviation, trigger the processor to compare the sensor data to the first template profile or the second template profile, or a combination thereof. In an example, the sensor comprises an infra-red (IR) image sensor, a thermal image sensor, an optical sensor, an electro-optical sensor, an ultrasonic sensor, a light sensor, a biometric sensor, a pressure sensor, a microwave sensor, an image sensor, a motion sensor or a video sensor, or a combination thereof. In an example, the device may comprise a desktop computer, a laptop computer, a mobile communications device, a mobile computing device, a tablet, a notebook, a detachable slate device, an Ultrabook™ system, a wearable communications device, or a wearable computer, or a combination thereof.

Disclosed herein are examples of one or more methods to detect a user motion proximate a device, comprising receiving, by a processor, sensor data corresponding to an area proximate the device, determining, by the processor, whether a differential value of a first point and a second point in the sensor data exceeds a threshold differential, wherein if the differential value exceeds the threshold differential then determining, by the processor, whether the first point is outside of a norm for the sensor data, wherein if the first point is determined to be outside of the norm then triggering, by the processor, execution of a user motion analysis and determining, by the processor, a user intent to engage or disengage the device based on the user motion analysis. In an example, the user motion analysis comprises comparing, by the processor, the sensor data to one or more template profiles associated with a particular user motion to identify a user motion indicative of a user intent to engage or disengage the device. The one or more template profiles may comprise a first waveform and a second waveform. In an example, the method may further comprise quantifying, by the processor, a match strength between the sensor data and the one or more template profiles, comparing, by the processor, the match strength to a threshold match strength, identifying, by the processor, a successful match to a template profile based on the comparing, determining, by the processor, a particular user motion represented by the sensor data based on the identifying the successful match and inferring, by the processor, the user intent to engage or disengage the device based on the particular user motion represented by the sensor data. In an example, the method may further comprise triggering, by the processor, a first action based on inferring a user intent to engage the device, wherein the first action is an authentication process, password process, a wake-up process or a facial recognition process, or a combination thereof or triggering, by the processor, a second action based on inferring a user intent to disengage the device, wherein the second action is a shutdown process, an energy saving mode, a secure mode, an upload of data, or an alarm or a combination thereof. In an example, the method may further comprise selecting, by the processor, the one or more template profiles based on a context of the device wherein the context of the device corresponds to whether the device is indoors, outdoors, a desktop device, a mobile device, a laptop device, or a slate device or a combination thereof. The one or more template profiles may be based on experimental data correlated to a context. In an example, the method may further comprise deriving, by the processor, the one or more template profiles during a calibration process wherein the sensor data is filtered or normalized or a combination thereof and wherein the sensor data comprises infra-red (IR) image sensor data, thermal image sensor data, optical sensor data, electro-optical sensor data, ultrasonic sensor data, light sensor data, biometric sensor data, pressure sensor data, microwave sensor data, image sensor data, motion sensor data, or video sensor data, or a combination thereof. The device may comprise a desktop computer, a mobile communications device, a mobile computing device, a tablet, a notebook, a detachable slate device, an Ultrabook™ system, a wearable communications device, or a wearable computer, or a combination thereof.

Referring now to FIG. 9, a block diagram of an information handling system capable of implementing a system for analyzing user motions in accordance with one or more embodiments will be discussed. User motion analyzing system 900 of FIG. 9 may tangibly embody any one or more of the elements described herein, above, including for example system 300 described above and depicted in FIG. 3 or system 400 described above and depicted in FIG. 4 with greater or fewer components depending on the hardware specifications of the particular device. Although user motion analyzing system 900 represents one example of several types of computing platforms, user motion analyzing system 900 may include more or fewer elements and/or different arrangements of elements than shown in FIG. 9, and the scope of the claimed subject matter is not limited in these respects.

In one or more embodiments, user motion analyzing system 900 may include an application processor 910 and a baseband processor 912. Application processor 910 may be utilized as a general-purpose processor to run applications and the various subsystems for user motion analyzing system 900. Application processor 910 may include a single core or alternatively may include multiple processing cores wherein one or more of the cores may comprise a digital signal processor or digital signal processing (DSP) core. Furthermore, application processor 910 may include a graphics processor or coprocessor disposed on the same chip, or alternatively a graphics processor coupled to application processor 910 may comprise a separate, discrete graphics chip. Application processor 910 may include on board memory such as cache memory, and further may be coupled to external memory devices such as synchronous dynamic random access memory (SDRAM) 914 for storing and/or executing applications during operation, and NAND flash 916 for storing applications and/or data even when user motion analyzing system 900 is powered off. In one or more embodiments, instructions to operate or configure the user motion analyzing system 900 and/or any of its components or subsystems to operate in a manner as described herein may be stored on an article of manufacture comprising a non-transitory storage medium. In one or more embodiments, the storage medium may comprise any of the memory devices shown in and described herein, although the scope of the claimed subject matter is not limited in this respect. Baseband processor 912 may control the broadband radio functions for user motion analyzing system 900. Baseband processor 912 may store code for controlling such broadband radio functions in a NOR flash 918. Baseband processor 912 controls a wireless wide area network (WWAN) transceiver 920 which is used for modulating and/or demodulating broadband network signals, for example for communicating via a 3GPP LTE or LTE-Advanced network or the like.

In general, WWAN transceiver 920 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 920 couples to one or more power amps 942 respectively coupled to one or more antennas 924 for sending and receiving radio-frequency signals via the WWAN broadband network. The baseband processor 912 also may control a wireless local area network (WLAN) transceiver 926 coupled to one or more suitable antennas 928 and which may be capable of communicating via a Wi-Fi, Bluetooth®, and/or an amplitude modulation (AM) or frequency modulation (FM) radio standard including an IEEE 702.11 a/b/g/n standard or the like. It should be noted that these are merely example implementations for application processor 910 and baseband processor 912, and the scope of the claimed subject matter is not limited in these respects. For example, any one or more of SDRAM 919, NAND flash 916 and/or NOR flash 918 may comprise other types of memory technology such as magnetic memory, chalcogenide memory, phase change memory, or ovonic memory, and the scope of the claimed subject matter is not limited in this respect.

In one or more embodiments, application processor 910 may drive a display 930 for displaying various information or data, and may further receive touch input from a user via a touch screen 932 for example via a finger or a stylus. Application processor 910 may receive sensor data 210 or other input via a IR Sensor 970. An ambient light sensor 934 may be utilized to detect an amount of ambient light in which information handling system 900 is operating, for example to control a brightness or contrast value for display 930 as a function of the intensity of ambient light detected by ambient light sensor 934. One or more cameras 936 may be utilized to capture images that are processed by application processor 910 and/or at least temporarily stored in NAND flash 916. Furthermore, application processor may couple to a gyroscope 938, accelerometer 940, magnetometer 942, audio coder/decoder (CODEC) 944, and/or global positioning system (GPS) controller 946 coupled to an appropriate GPS antenna 948, for detection of various environmental properties including location, movement, and/or orientation of user motion analyzing system 900. Alternatively, controller 946 may comprise a Global Navigation Satellite System (GNSS) controller. Audio CODEC 944 may be coupled to one or more audio ports 950 to provide microphone input and speaker outputs either via internal devices and/or via external devices coupled to information handling system via the audio ports 950, for example via a headphone and microphone jack. In addition, application processor 910 may couple to one or more input/output (I/O) transceivers 952 to couple to one or more I/O ports 954 such as a universal serial bus (USB) port, a high-definition multimedia interface (HDMI) port, a serial port, and so on. Furthermore, one or more of the I/O transceivers 952 may couple to one or more memory slots 956 for optional removable memory such as secure digital (SD) card or a subscriber identity module (SIM) card, although the scope of the claimed subject matter is not limited in these respects.

In an example, processor 202 and/or memory 204 may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processor 202 and/or memory 204 may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a conventional rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or the like, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

Having described and illustrated the principles of examples, it should be apparent that the examples may be modified in arrangement and detail without departing from such principles. We claim all modifications and variations coming within the spirit and scope of the following claims.

What is claimed is:

1. A method, comprising:
receiving sensor data representative of temperature information captured in a field of view of an infrared (IR) sensor;
detecting if a temperature differential in the received sensor data exceeds a threshold value;
quantifying a similarity between the sensor data received during the detected temperature differential and one or more stored profiles; and
determining a presence or an absence of a user in the field of view of the IR sensor based on the similarity between the data received during the detected temperature differential and at least one of the stored profiles.

2. A method as claimed in claim 1, wherein the one or more stored profiles comprises a profile for a user entering the field of view of the IR sensor.

3. A method as claimed in claim 1, wherein the one or more stored profiles comprises a profile for a user exiting the field of view of the IR sensor.

4. A method as claimed in claim 1, further comprising updating at least one of the stored profiles with the data received during the detected temperature differential if said determining determines the presence or absence of the user.

5. A method as claimed in claim 1, further comprising continuously calculating a standard deviation on frames of samples in the sensor data and using a standard deviation threshold in said determining to determine a presence or absence of the user.

6. A method as claimed in claim 1, wherein said quantifying comprises normalizing a cross-correlation between the sensor data received during the detected temperature differential and the one or more stored profiles.

7. A method as claimed in claim 1, further comprising authorizing the user to access an electronic device if the sensor data received during the detected temperature differential matches one of the one or more stored profiles.

8. A device to detect a user approach or departure or a combination thereof, comprising:
a sensor to collect sensor data; and
a processor to compare the sensor data to a first template profile comprising data indicative of an approach of a user or compare the sensor data to a second template profile comprising data indicative of a departure of a user, or a combination thereof to determine whether the sensor data indicates the approach of a user or a departure of a user.

9. The device of claim 8, wherein the processor is further to:
trigger a first action if the sensor data indicates the approach of the user; and
trigger a second action if the sensor data indicates the departure of the user, or a combination thereof.

10. The device of claim 8, wherein the processor is to:
quantify a similarity between the sensor data and the first template profile to generate a first normalized cross correlation coefficient between the sensor data and the first template profile; and
quantify a similarity between the sensor data and the second template profile to generate a second normalized cross correlation coefficient between the sensor data and the second template profile.

11. The device of claim 10, wherein the processor is to compare a threshold coefficient value with the first cross correlation coefficient or the second cross correlation coefficient, or a combination thereof to identify the approach or departure of the user.

12. The device of claim 8, wherein the first template profile is a first waveform and the second template profile is a second waveform.

13. The device of claim 12, wherein the processor is further to select the first waveform or the second waveform or a combination thereof based on a context of the device.

14. The device of claim 13, wherein the context of the device corresponds to whether the device is indoors, outdoors, a desktop device, a mobile device, a laptop device, or a slate device or a combination thereof.

15. The device of claim 8, wherein the processor is to:
determine a differential between a first sample value and a second sample value of the sensor data measuring a particular metric;
compare the differential to a threshold differential value;
responsive to the differential exceeding the threshold differential value, trigger determination of an average value and a standard deviation of the average value of the particular metric for a set of samples of the sensor data;
compare the first sample value with the average and determine whether the first sample value is within a threshold standard deviation of the average value; and
responsive to the first sample value exceeding the threshold standard deviation, trigger the processor to compare the sensor data to the first template profile or the second template profile, or a combination thereof.

16. The device of claim 8, wherein the sensor comprises an infra-red (IR) image sensor, a thermal image sensor, an optical sensor, an electro-optical sensor, an ultrasonic sensor, a light sensor, a biometric sensor, a pressure sensor, a microwave sensor, an image sensor, a motion sensor or a video sensor, or a combination thereof.

17. The device of claim 8, wherein the device comprises a desktop computer, a laptop computer, a mobile communications device, a mobile computing device, a tablet, a notebook, a detachable slate device, an Ultrabook™ system, a wearable communications device, or a wearable computer, or a combination thereof.

18. A method to detect a user motion proximate a device, comprising:
receiving, by a processor, sensor data corresponding to an area proximate the device;
determining, by the processor, whether a differential value of a first point and a second point in the sensor data exceeds a threshold differential;
if the differential value exceeds the threshold differential then determining, by the processor, whether the first point is outside of a norm for the sensor data;
if the first point is determined to be outside of the norm then triggering, by the processor, execution of a user motion analysis; and
determining, by the processor, a user intent to engage or disengage the device based on the user motion analysis.

19. The method of claim 18, wherein the user motion analysis comprises comparing, by the processor, the sensor data to one or more template profiles associated with a particular user motion to identify a user motion indicative of a user intent to engage or disengage the device.

20. The method of claim 19, further comprising:
quantifying, by the processor, a match strength between the sensor data and the one or more template profiles; and
comparing, by the processor, the match strength to a threshold match strength;
identifying, by the processor, a successful match to a template profile based on the comparing;
determining, by the processor, a particular user motion represented by the sensor data based on the identifying the successful match; and
inferring, by the processor, the user intent to engage or disengage the device based on the particular user motion represented by the sensor data.

21. The method of claim 18, further comprising:
triggering, by the processor, a first action based on inferring a user intent to engage the device, wherein the first action is an authentication process, password process, a wake-up process or a facial recognition process, or a combination thereof; or
triggering, by the processor, a second action based on inferring a user intent to disengage the device, wherein the second action is a shutdown process, an energy saving mode, a secure mode, an upload of data, or an alarm or a combination thereof.

22. The method of claim 20, wherein the device comprises a desktop computer, a mobile communications device, a mobile computing device, a tablet, a notebook, a detachable slate device, an Ultrabook™ system, a wearable communications device, or a wearable computer, or a combination thereof.
